(19) United States
(12) Patent Application Publication
(10) Pub. No.: US 2007/0208491 A1
(43) Pub. Date: Sep. 6, 2007

(54) Wireless security and monitoring system for mechanized equipment

(76) Inventors: Bruce D. Miller, North Reading, MA (US); C. Scott Wilkin, Plano, TX (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/365,744

(22) Filed: Mar. 1, 2006

(51) Int. Cl. G06F 19/00

(52) U.S. Cl. 701/113

(57) ABSTRACT

A proximity based security and monitoring system that does not require a mechanical interconnect between operator(s), passenger(s) and the vehicle. The system is based upon one or more transponders that can be mounted on the operator's and/or passenger's person. The transponder can include a predetermined security code required to start the vehicle or a generalized presence may be used to enable starting and continued operation of the vehicle. A list of monitored transponders is set up and the vehicle looks for the transponders to be local to the vehicle. If a transponder does not meet the acceptance criteria (potentially moved a distance D from the vehicle), then the vehicle enters a safety mode. The system supports the implementation of both a vehicle security system and monitoring system that does not rely on a mechanical interconnect.

### BACKGROUND

Security and safety are critically important in the operation of personal watercraft, snowmobiles, all terrain vehicles and other motorized equipment. Traditionally, the integrity of the operator and the vehicle was managed by using a lanyard that provides a mechanical connection between the vehicle and the operator. In the event that the operator falls off the equipment or suffers an event that causes separation from the vehicle, then the lanyard is mechanically separated from the vehicle. In some instances, the separation is detected mechanically by the opening or closing of a switch. In other cases, it is detected electronically when contacts are removed from the mating set on the vehicle. In either of these cases, the vehicle enters a safety mode. This mode will vary depending upon the manufacturer of the vehicle and the specific safety requirements. In many cases, the motor in the vehicle is shut off.

An issue with the prior art is that the lanyard relies upon a mechanical connection between the operator and the vehicle. This is typically a tether that is connected to the vehicle and the operator. The tether itself is a safety hazard as it can become entangled and prevent the operator from properly operating the vehicle or become a distraction. In many cases, operators disable this system creating a potential safety hazard in the event that they become separated from the vehicle.

In many motorized applications (e.g. snowmobiles, watercraft etc.) lanyards are used to insure that the rider is in physical presence of the vehicle. There are a number of mechanisms used to provide an indication to the vehicle of this presence.

FIG. 1 shows a typical mechanical application using a tether. One side of a set of handlebars 1 is show in FIG. 1. The operator uses the handlebars to control the direction of the vehicle. It should be noted that some vehicles (such as tractors) would use a steering wheel as an alternative. A start switch 2A for starting the vehicle is shown at the top of the housing. An emergency stop or safety switch 2B protrudes from the housing on the handle bar. This switch is held in “on” position by the lanyard plate 3 enabling normal operation of the craft. The safety switch is spring loaded and biased toward the “stop” position. The lanyard plate pushes against the spring and holds the switch in the operational state. The tether cord 4 attaches to the lanyard plate 3 on one end and to the operator on the other. When the operator falls off (or leaves) the vehicle, the lanyard plate is pulled from the emergency stop switch and the vehicle enters the safety mode (typically a preemptive stop).

FIG. 2 shows an electro-mechanical embodiment of the lanyard. A lanyard cap 5 contains a digital circuit that makes contact with two contact points on the interior cavity. When the lanyard cap is placed over the mating device 6, the vehicle powers the digital circuit in the lanyard cap and it provides a digital code back to the vehicle. If this digital code matches a stored code(s) in the vehicle, then the vehicle is allowed to start. This system provides a degree of theft protection in that the lanyard's code must match a code stored in the vehicle. Typically, the lanyard is an enabling device that allows the vehicle to start by means of a start switch 2A as shown in FIG. 1.

When an operator falls from the vehicle, the lanyard cap 5 is pulled from the mating device 6 and the vehicle detects electrically that a mechanical separation has occurred. This will cause the vehicle to go into a safety mode, typically, that will be to shut off the engine.

FIG. 3 shows a hybrid implementation wherein the lanyard 3 now uses a completely enclosed digital circuit 8. An enclosure on the vehicle 9 contains a hybrid wireless reader 10 and a mechanical kill switch 11. A plunger assembly 12 is biased by spring 13 such that contacts 14 and 15 are electrically mated. In this position, the vehicle engine is in the disable state and will not operate.

FIG. 4 shows the system in the operational state. The lanyard 3 is inserted in the assembly and mechanically pulls out the plunger assembly 12 that was biased by spring 13. In this position contacts 14 and 15 are now electrically separated and the kill switch is in a position that will allow the engine to operate provided the wireless reader 10 reads the correct security codes from the digital circuit 8. If the rider falls from the vehicle, then lanyard 3 is pulled away from the plunger assembly 12 via the tether 4. This causes the kill switch 11 to stop the engine.

### SUMMARY

The present invention is directed to a proximity based activation and safety system. A lanyard having a transponder is placed upon the person of the operator and can be used as a proximity sensor to determine that the operator is within a range of the vehicle. This technique can also be extended to passengers and provide a mechanism for detecting that a passenger has moved outside of a range of the vehicle. Such an event can occur if a passenger were to fall off the operating vehicle. Embodiments of the invention obviate the need for a mechanical (tether) interconnect between the operator and the vehicle.

According to one aspect of the invention, an immobilization system for a vehicle includes a lanyard member with an electronic transponder containing a wireless transponder circuit supporting a plurality of codes. Additionally, the system contains a communication device to communicate with the transponder to determine whether the transponder is within an appropriate distance to the vehicle. The lanyard member does not have to maintain a mechanical relationship with the vehicle (e.g., using a tether) but rather, the communication device will detect in a wireless fashion that the transponder is within a range. In this way, the operator is not encumbered with a mechanical link to the vehicle.

Another aspect of the invention is to provide a monitoring function, wherein a passenger can be monitored (in addition to the operator). A transponder can be affixed to the passenger and monitored for proximity. In this way, the vehicle can enter a safety mode in the event that either the operator or a passenger falls off or otherwise is separated from the vehicle.

Accordingly, a security and monitoring system for motorized vehicles comprises one or more transponders; a communication device configured to receive a plurality of codes from the transponders without direct electrical or mechanical connection between the transponders and the communication device; and an engine control device configured to enable operation of the engine based upon the detection of one or more valid codes.

An adaptor for motorized vehicles comprises a communication device configured to receive a plurality of codes from the transponders without direct electrical or mechanical connection between the transponders and the communication device; and a vehicle interface responsive to the communication device to control operation of a vehicle based upon the detection of one or more valid codes.

Further aspects, features and advantages of the present invention will become apparent from the detailed description of the preferred embodiments that follow.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates a mechanical application using a tether (Background Art).

FIG. 2 illustrates an electromechanical lanyard (Background Art).

FIG. 3 shows a hybrid lanyard system (Background Art).

FIG. 4 shows the system of FIG. 3 in operation (Background Art).

FIG. 5 illustrates a lanyard assembly in accordance with the principles of the present invention.

FIG. 6 is a schematic block diagram of an embodiment of the lanyard assembly according to the present invention.

FIG. 7 is a schematic block diagram of antenna interface circuitry of the lanyard embodiment of FIG. 6.

FIG. 8 illustrates a first control subroutine in accordance with the present invention.

FIG. 9 illustrates a second control subroutine in accordance with the present invention.

FIG. 10 illustrates a first embodiment of an adaptor assembly in accordance with the principles of the present invention.

FIG. 11 illustrates a programming station in communication with the adaptor assembly of FIG. 10.

FIG. 12 illustrates a second embodiment of an adaptor assembly in accordance with the present invention.

### DETAILED DESCRIPTION

The present invention is directed to an immobilization and safety system for a vehicle. In general, embodiments of the invention include a lanyard assembly which has a wireless transponder circuit with a security code. The lanyard does not require a mechanical attachment as a safety mechanism, rather the proximity of the lanyard is determined between the transponder and a monitoring circuit at the vehicle and if the operator exceeds a distance from the vehicle, it can be used to put the vehicle into a safety mode. In addition, this mechanism can be used to monitor a number of passengers. A passenger is differentiated from an operator in that the passenger's lanyard does not have vehicle operation privileges.

Those of skill in the art will appreciate that the invention has particular utility for watercraft and snowmobiles, but can be used or adapted for use in a number of other settings, for example, without limitation, open hull boats.

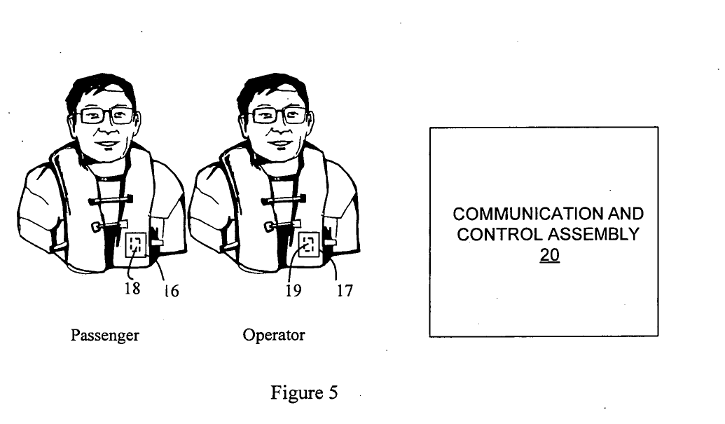

Principles of the present invention are illustrated with reference to FIG. 5, wherein a lanyard assembly shown as 16 and 17 is affixed to a passenger and operator respectively. In this application, the passenger is not necessarily required; however, the ability to monitor passengers is one additional advantage of the invention. Within the transponder of the lanyard 16, 17 is an analog or digital circuit shown as 18 and 19. This type of transponder is of a type that is well known in the art. The transponder is configured to send a signal when it receives a signal from an outside source. The transponder can potentially derive its power from this source or contain an internal power source. The transponder will send its code based upon the receipt of the appropriate signal. Preferentially, this is a unique signal that contains a security code, however, that is not requisite. In the simplest embodiment, the presence of the transponder and the class of code are all that is needed. In order to provide security, the transponder can emit a unique code that must match a code in the vehicle or as provided to the vehicle.

The transponder communicates with a communication and control assembly 20. The assembly can be mounted as appropriate in a vehicle, by way of example, this could be an assembly on the handle bars or control panel of a watercraft. The communication and control assembly communicates with the transponder and may be arranged to provide communication in one or many directions depending upon the specific application. The vehicle is started via a startup mode. In this mode, the vehicle will determine that the conditions to start are met and will (optionally) determine whether there are any passengers that need to be monitored. If the startup conditions are met, the vehicle energizes the engine and allows normal operation of the vehicle. During this time, the set of passengers and operator(s) that are detected at startup are monitored. If a passenger or operator's signal is lost or detected to be beyond a particular level corresponding to an appropriate distance, then the vehicle will go into a safety mode. The operator(s) and passenger(s) list may be modified during the normal operation of the vehicle based upon initiating a re-polling operation. This allows passengers and potential operators to enter and exit the vehicle and preventing entry into the safety mode or being excluded from the monitoring list.

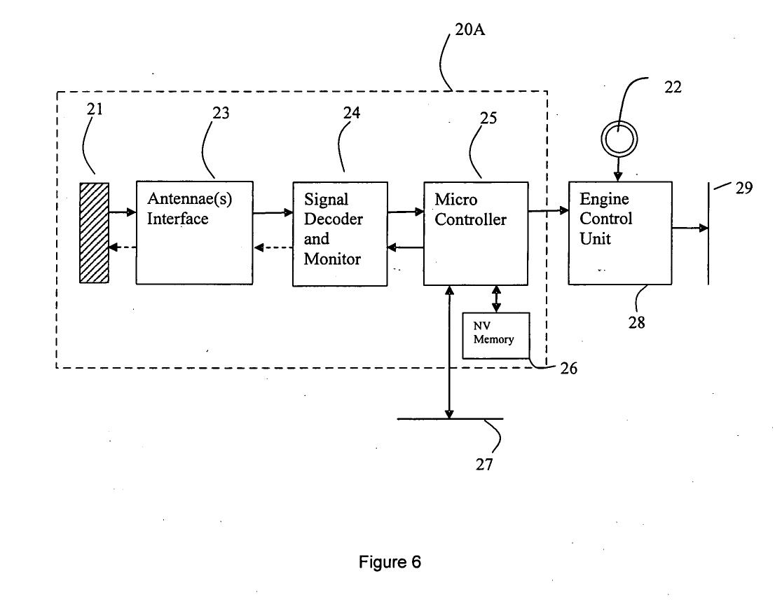

FIG. 6 shows details of an embodiment of communication and control assembly 20 which includes a communication device 20A and engine control unit 28. The communication device 20A includes antenna complex 21, antenna interface 23, signal decoder and monitor 24, microcontroller 25 and memory 26. The antenna or antenna complex 21 is used to communicate with the transponder(s) 18 and 19. The antenna or antenna complex 21 may be arranged based upon the appropriate areas of use of the vehicle. The antenna complex may be arranged to either operate purely as a receiver or may emit a signal to interoperate or power the transponder. The antenna interface 23 provides the circuitry to interface to the antenna(s) in order to provide amplification, signal conditioning and (optionally) antenna drive. The antennae interface 23 communicates with the signal decoder and monitoring system 24. This system is responsible for the decoding of the transponder signals and separation of the individual transponder codes from the aggregate signal. The system may operate based upon a system that receives the signals en mass and extracts the individual codes based upon the coding schema or provides excitation to the transponders in order to individually poll them. The decoder and monitoring system 24 is also responsible for determining whether the signal coming from the transponder meets the criteria for being within appropriate range of the vehicle. This is typically based upon the transponder being within the operating range of the assembly 20 based upon signal strength and sensitivity. The sensitivity can be adjusted to correspond with a signal strength and relative distance.

The signal decoder and monitoring system 24 interfaces with a microcontroller 25. This portion of the system provides the programming and intelligent control for the system. The microcontroller interfaces with a programming interface 27 that is used to program the set of permissible codes and their attributes into the system. A transponder can be programmed as an operator without restrictions. For security, operator codes should be programmed with some form of security while the system might use the another interface (polling and confirmation) through the RF interfaces to enter the passenger codes. The codes are stored in an NV Memory System 26 and are retained even when power is removed from the vehicle. The microcontroller 25 interfaces with an engine control unit 28. The engine control unit is responsible for enabling operation of the engine, disabling operation of the engine and providing operational limitations (such as speed limits). An engine start/stop switch 22 allows the engine to start provided the microcontroller agrees that this is permissible. When the engine is running, the stop switch can be used to provide a pre-emptive stop of the engine.

The development of the antenna complex is specific to the overall application. The design of the antennas is well known and the following links show examples of the type of information that is in the public domain:

http://www.ti.com/rfid/docs/manuals/appNotes/HFAntennaDesignNotes.pdf

http://www.ti.com/rfid/docs/manuals/appNotes/HFAntennaCookbook.pdf

http://www.ti.com/rfid/docs/manuals/appNotes/lf_reader_intro.pdf

The size and the geometry of the antenna is designed to match the frequency and power/sensitivity requirements of the application. The design guides show several physical designs. The antenna should be resonance matched to correct spectral range with a tuning capacitor and the overall Q of the antenna is tuned using a damping resistor. The antenna should be impedance matched to the reader system and this is typically done using a balun.

For embodiments that use an active tag, the antenna design may be based upon pure sensitivity as there is not any requirement to couple energy to the transponder. In embodiments that use a passive tag, the antenna provides energy to the tag. This energy can be coupled either inductively at low/high frequencies (standard RFID typically uses either a low frequency range of 124 khz, 125 khz, or 135 khz and a high frequency range of 860-960 Mhz). The inductive coupling is the primary limitation to overall system read distance and much of the industry focus is now on UHF implementations. The UHF system provides energy to the tag using propagation coupling instead of inductive coupling. As such, the tag does not have to be in the magnetic near field and can operate in the electromagnetic far field. The tag operates by changing the loading on the antenna and the signal is read as a reflected backscatter. Encodings for this technology vary.

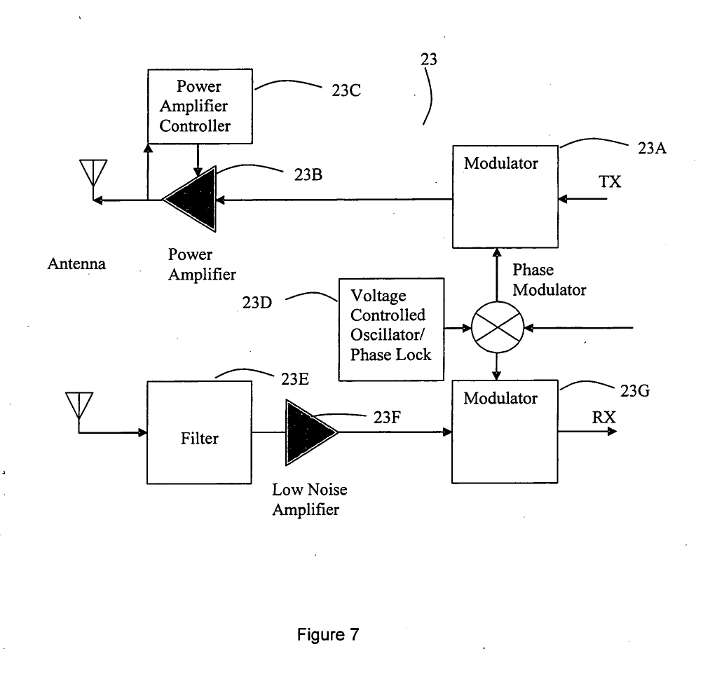

The antenna interface complex 23 can vary as a function of the technology used for the particular application. FIG. 7 illustrates one typical antenna configuration. The configuration includes transmit modulator 23A, power amplifier 23B, power amplifier controller 23C, frequency reference and phase lock 23D, receive filter 23E, low noise amplifier 23F and receive modulator 23G. If the antenna drives an electromagnetic field, that field is driven at a particular frequency and typically the tag will operate at a different frequency. The PLL is used to lock onto the signal that is detected by the antenna complex. In the event that propagation coupling is used, then the backscatter signal must be detected.

The microcontroller 25 executes the sequencing and uses the interface to device 24 in order to initiate tag polling and response. The engine control unit 28 is the interface to the engine and is the block responsible for enabling the engine and any limitation of operational mode. It is also the block that enables either the engine kill or safety mode.

The signal decoder and monitor 24 is a decoder that can translate the encoding scheme between the transponder and the reader to a bit/byte readable format for the microcontroller. It may have some degree of intelligence such that it can read a plurality of codes and send them to the microcontroller. The logic contained in this block is a function of the encoding schema and the microcontroller.

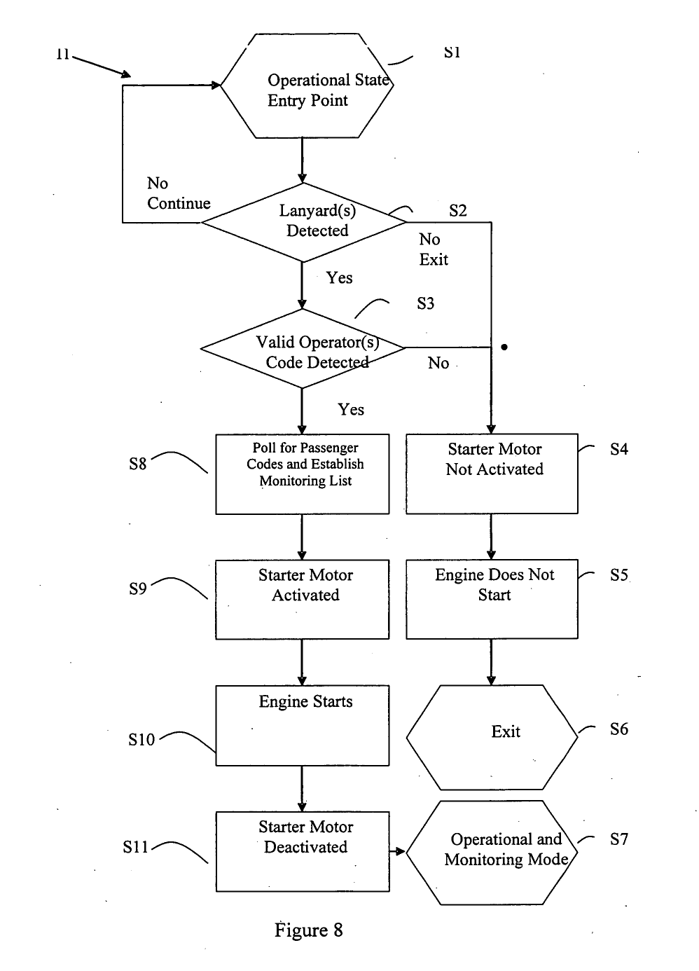

With reference to FIG. 8, a control subroutine I1 in accordance with another aspect of the invention is illustrated therein. As shown, subroutine I1 is initiated through step S1. In step S1, the vehicle enters a state in preparation for operation. This may be initiated by a potential operator through a switch as in 22, a key or simply as a default state of the vehicle or another mechanism. In step S2 a polling operation occurs to scan for lanyard(s) such as 17 that are in range of the communication device 21. In step S2, if there are no lanyards in range, then there are two potential actions. Either the subroutine will return to step S1 and loop through step S2 looking for lanyards, or the loop can be terminated by an exit condition. The exit condition may be (but not limited to) an action of intervention, some number of polling loops or a polling timeout. In step S2, a lanyard (or lanyards) may be found to be within range of communication device 21; this may be a simple validation of presence or validation of a security code. If a lanyard is detected to be within range and meeting the criteria of step S2, then the routine progresses to step S3. In step S3 a determination is made whether the lanyard(s) detected contain a member of a group with operational privileges. This is a group that is known to the vehicle and either programmed into the vehicle or made known to it by other means. This may also be the operational step for validating or revalidating a security code. Within the operational group, it is possible to assign different levels of privilege. For example, there may be an unrestricted privilege that supports access to all operation or features of the vehicle, or restricted privilege that blocks access to features or operational modes. If multiple operators with different privileges are detected, a resolution criteria can be invoked in step S3 in setting the operational mode of the vehicle.

If there is no lanyard that supports operational privileges, a lanyard is no longer in range or there is some other variation in acceptance criteria, the routine will progress to step S4. Step S4 is also the exit path from step S2 (as previously discussed). In step S4, the starter motor is not activated and the sequence progresses to step S5. In step S5, the engine does not activate and the sequence progresses to step S6. Step S6 is an exit of the subroutine and it results in the vehicle not entering an operational state and the subroutine must be invoked again to attempt to activate the vehicle. If the criteria of step S3 (as previously mentioned) are met, then the sequence will progress to step S8. In step S8, a polling of valid lanyards is made in order to populate a passenger list. The vehicle will likely have a list of lanyard codes that constitute the valid population of passenger/operator lanyards and candidates for the monitoring list. It is permissible to poll all lanyards without bias toward such a list; however, care must be taken to avoid populating the list with lanyards that do not belong to the operator or passenger set of the vehicle. Once the monitoring list is populated, the sequence can progress to step S9. In step S9, the starter is activated and the sequence proceeds to step S10. Step S10 starts the engine and subsequently step S11 deactivates the starter motor. Finally, control is passed to the operational and monitoring mode S7. Step S7 is the operational mode for the vehicle and control is passed to that subroutine as subroutine 11 is exited.

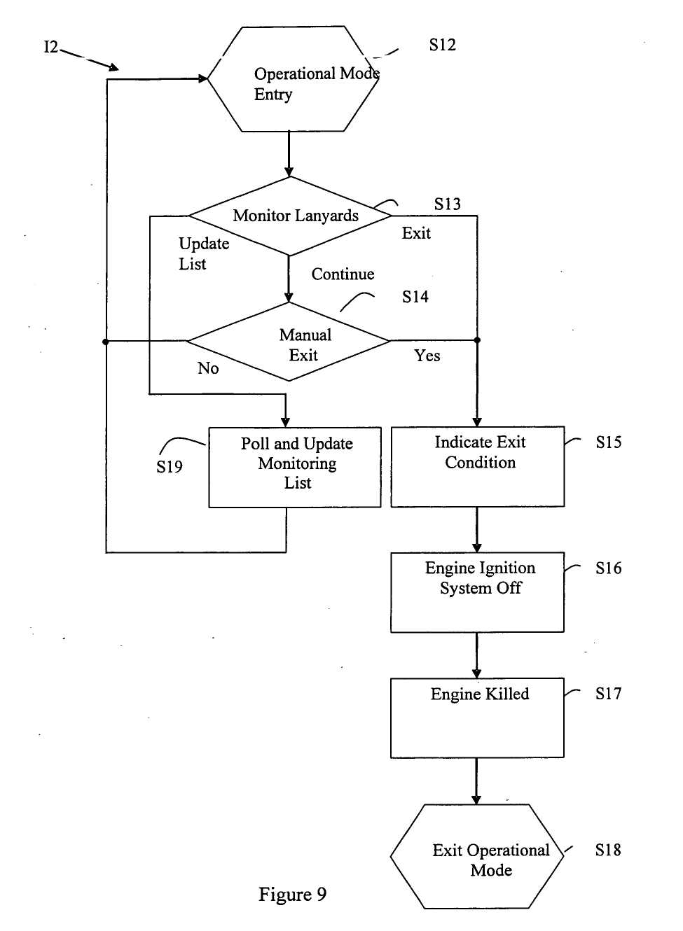

With reference to FIG. 9, a control subroutine I2 composed in accordance with another aspect of the invention is illustrated therein. Control is passed to this subroutine based upon exiting subroutine I1 via step S7. The entry point to subroutine I2 is step S12. Step S12 establishes operational conditions for the vehicle and maintains those conditions. It passes control over to step S13, wherein the established list of lanyards is monitored. If the monitoring step S13 detects that a lanyard has exited the population (e.g., moved a distance D away from the vehicle), then the sequence moves to step S15. If the list is proper and all members meet the monitoring conditions and there is no request to update the list, then control moves to step S14. If the list is proper and all members meet the monitoring conditions and there is a request to update the list, then the sequence moves to step S19. In step S19, the monitoring list is updated with a new poll. This is useful if a passenger enters or exits the vehicle under normal operating conditions and the operator needs to update the monitoring list without shutting down the vehicle. Once the list is properly populated, then control is passed to step S12. It is possible that this list could not be reestablished or a problem occurred in which case, a flag can be set such that step S13 or S14 will cause and exit by passing control over to step S15. In step S14, a check is made to see whether a manual exit is required. At this point, a request may come from the operator to enter the safety mode (in this case, shut down the vehicle). In step S15, indication is made denoting that the vehicle is entering the safety mode. Control is passed to step S16 and the ignition to the vehicle is shut off. Control is passed to step S17 where the engine is in the “killed” or inactive state and the sequence exits the routine at step S18.

There are two forms of lanyard implementations in the market comprising prior art. Adaptor embodiments in accordance with the present invention provide a system to translate between the existing lanyard systems and a wireless system with monitoring capabilities.

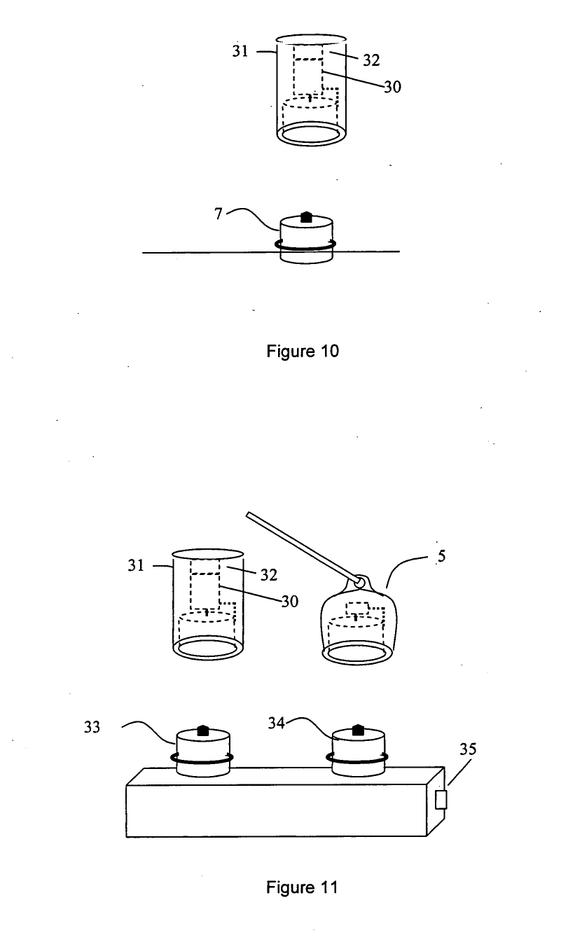

FIG. 10 shows a first embodiment of an adaptor 31. The first embodiment stores the security code to activate the vehicle and uses that code to enable operation of the vehicle based upon proper receipt of an operator code from the transponders. The system works similarly to that described above in that the adapter polls for a set of transponders (optionally based upon a poll button—not shown below) and uses that list to maintain normal operation of the vehicle. If a member of the list is removed, then the adaptor will signal to the vehicle that the lanyard has been disconnected. This will cause the vehicle to react as though the adaptor had been pulled off, similar to the prior art adaptor being removed.

The adaptor 31 provides the interaction between the lanyard transponder or tag and the vehicle. Block 32 provides the antenna captured in the adaptor and used to communicate with the tag. Block 30 functionally corresponds to device elements 24, 25, 26, 27 the system shown in FIG. 6. A vehicle interface replaces the engine control unit. The vehicle interface is used to control the vehicle via the existing transponder interface. This interface may be of the type shown in FIG. 10 wherein codes are passed from an IC in the legacy transponder to the vehicle constituting a security system. At least two types of providing a disable mode are contemplated for use with the adaptor 31. A first type of disable mode may be based upon whether the code is polled and lack of response kills the engine. In another embodiment, the disable mode may be based upon whether there is a pilot current and interruption of the pilot current stops the engine.

FIG. 11 shows a programming station for the adaptor of FIG. 10. A lanyard that would normally operate the vehicle is plugged into position 34 and then is interrogated for its code. That code then is stored in the adaptor. During the programming session, control is handled through a PC interface and the programming is done through a routine provided to the customer with the purchase of the adaptor. During the programming the adaptor will be coded to recognize the wireless lanyards and ascribe either operator privileges or passenger to the lanyard. Only operator lanyards will be allowed to start the vehicle.

It is permissible to have multiple programming sessions with multiple lanyards (5). This allows the adaptor to build a linkage between operator transponders and the code received from the lanyard. Manufacturers do provide speed limited lanyards and therefore an operator lanyard could be associated with a speed limited lanyard code and the system would ascribe that attribute to the transponder.

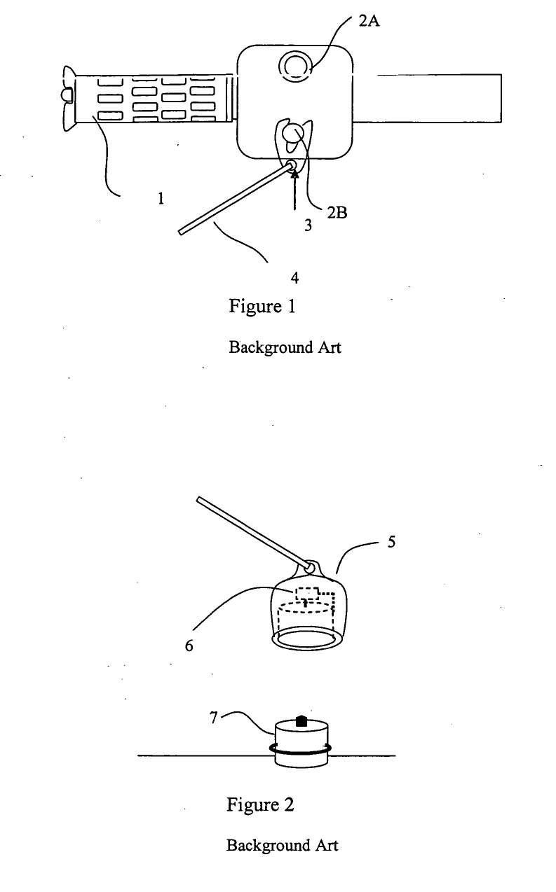

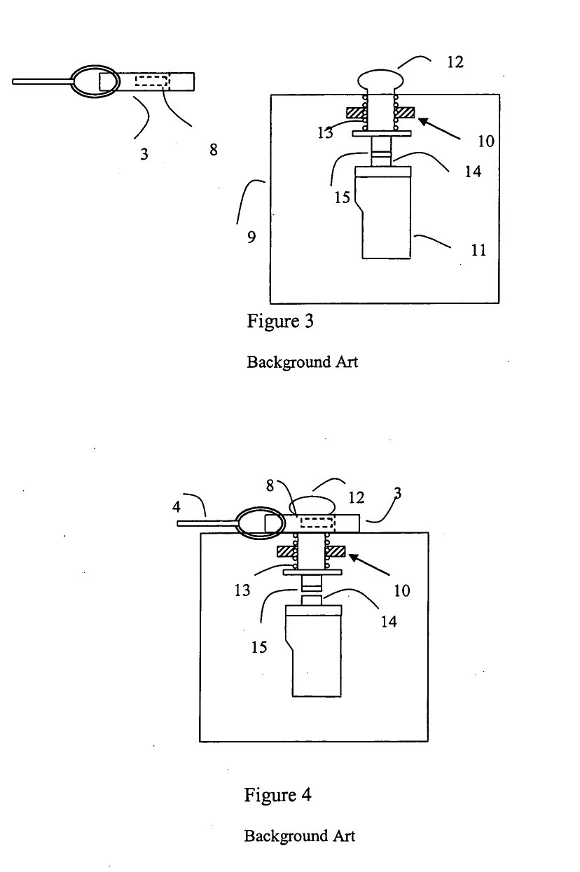

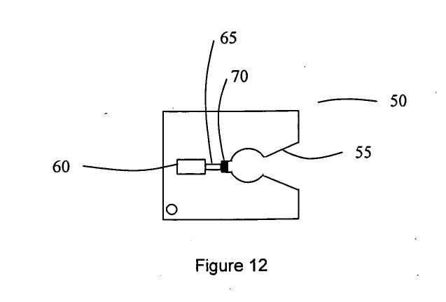

FIG. 12 shows another embodiment of an adaptor 50. In this case, there is no electrical interface to the vehicle. The adaptor includes a lanyard plate 55 that acts to keep the adaptor in place and mechanically maintain the kill switch (e.g., similar to the kill switch shown in FIG. 1) in an operating position. When activated based upon a detected disabling event of the type described above, an actuator or captive solenoid 70 pops the lanyard off of the vehicle to kill the engine.

The adaptor includes a transponder 65 and adaptor circuitry 60 in communication with the captive solenoid 70. The adaptor circuitry 60 is similar to the circuitry 30 (FIG. 10); however, there is no mode for security or activation of the vehicle since a simple mechanical relationship exists between the vehicle and the adaptor. The adaptor circuitry 60 features a mechanism to initiate a poll and then monitor the tags. If the monitoring interval indicates that a tag is out of range, then the solenoid will pop the adaptor from the vehicle.

While this invention has been particularly shown and described with references to preferred embodiments thereof, it will be understood by those skilled in the art that various changes in form and details may be made therein without departing from the scope of the invention encompassed by the appended claims.

What is claimed is:

1. A security and monitoring system for motorized vehicles comprising:
one or more transponders;
a communication device configured to receive a plurality of codes from the transponders without direct electrical or mechanical connection between the transponders and the communication device; and
an engine control device configured to enable operation of the engine based upon the detection of one or more valid codes.

2. The security and monitoring system in accordance with claim 1, wherein the valid codes include at least one operator code associated with an operator.

3. The security and monitoring system in accordance with claim 2, wherein the valid codes further includes one or more passenger codes associated with corresponding passengers.

4. The security and monitoring system in accordance with claim 1, wherein each transponder is mounted in a corresponding lanyard member without requiring electrical or mechanical contact between the vehicle and the lanyard member.

5. The security and monitoring system in accordance with claim 1, wherein the vehicle is configured not to start unless a valid operator code is detected.

6. The security and monitoring system in accordance with claim 1, wherein a set of operational privileges can optionally be assigned based upon the type of operator code that is assigned to the transponder and detected by the communication device.

7. The security and monitoring system in accordance with claim 1, wherein the communication device is programmed with a predetermined list of passenger/security codes and their associated privileges or is passed from a programming device to the communication device.

8. The security and monitoring system in accordance with claim 1, wherein the communication device is programmed with a predetermined list of passenger codes and their associated privileges or is passed from a programming device to the communication device.

9. The security and monitoring system in accordance with claim 1, wherein the communication device polls for a list of operator and passenger codes as part of an initialization sequence and optionally when invoked during normal operation.

10. The security and monitoring system in accordance with claim 9, wherein the communication device maintains the list of operator and passenger codes and uses the list to monitor the operator and passengers to validate that the operator and passengers are within an established range of the vehicle.

11. An adaptor for motorized vehicles comprising:
a communication device configured to receive a plurality of codes from the transponders without direct electrical or mechanical connection between the transponders and the communication device; and a vehicle interface responsive to the communication device to control operation of a vehicle based upon the detection of one or more valid codes.

12. The adaptor accordance with claim 11, wherein the valid codes include at least one operator code associated with an operator.

13. The adaptor in accordance with claim 12, wherein the valid codes further includes one or more passenger codes associated with corresponding passengers.

14. The adaptor in accordance with claim 11, wherein the vehicle is configured not to start unless a valid operator code is detected.

15. The adaptor in accordance with claim 11, wherein a set of operational privileges can optionally be assigned based upon the type of operator code that is assigned to the transponder and detected by the communication device.

16. The adaptor in accordance with claim 11, wherein the communication device is programmed with a predetermined list of passenger/security codes and their associated privileges or is passed from a programming device to the communication device.

17. The adaptor in accordance with claim 11, wherein the communication device is programmed with a predetermined list of passenger codes and their associated privileges or is passed from a programming device to the communication device.

18. The adaptor in accordance with claim 11, wherein the communication device polls for a list of operator and passenger codes as part of an initialization sequence and optionally when invoked during normal operation.

19. The adaptor in accordance with claim 18, wherein the communication device maintains the list of operator and passenger codes and uses the list to monitor the operator and passengers to validate that the operator and passengers are within an established range of the vehicle.
